(19) United States
(12) Patent Application Publication
(10) Pub. No.: US 2020/0151742 A1
(43) Pub. Date: May 14, 2020

(54) INFORMATION PROCESSING SYSTEM, PROGRAM, AND CONTROL METHOD

(71) Applicant: TOYOTA JIDOSHA KABUSHIKI KAISHA, Toyota-shi (JP)

(72) Inventors: Kana HAMAGAMI, Nissin-shi (JP); Takuya Maekawa, Nissin-shi (JP); Yosuke Nakayama, Owariasahi-shi (JP); Akitoshi Jikumaru, Nissin-shi (JP); Tae Sugimura, Miyoshi-shi (JP); Takao Hishikawa, Nagoya-shi (JP); Shinichi Adachi, Takahama-shi (JP)

(73) Assignee: TOYOTA JIDOSHA KABUSHIKI KAISHA, Toyota-shi (JP)

(21) Appl. No.: 16/590,561

(22) Filed: Oct. 2, 2019

(30) Foreign Application Priority Data
Nov. 14, 2018 (JP) 2018-214065

(51) Int. Cl. G06Q 30/02; H04W 4/029; H04W 4/44; G06K 9/00

(52) U.S. Cl. CPC G06Q 30/0201; H04W 4/029; G06K 9/00845; G06K 9/00791; H04W 4/44

(57) ABSTRACT

An information processing system includes a vehicle and an information processing apparatus that acquires, from the vehicle, information acquired by the vehicle. The vehicle acquires information on an occupant inside a vehicle cabin of the vehicle and acquires position information of the vehicle. When the information processing apparatus determines that the vehicle is to pass a pre-registered point based on the position information of the vehicle, the information processing apparatus associates at least one of information on the occupant acquired at the point and information calculated based on the information on the occupant with position information of the point, and provides the information associated with the position information of the point to a service provider for a store located at the point.

### INCORPORATION BY REFERENCE

The disclosure of Japanese Patent Application No. 2018-214065 filed on Nov. 14, 2018 including the specification, drawings and abstract is incorporated herein by reference in its entirety.

### BACKGROUND

### 1. Technical Field

The present disclosure relates to an information processing system, a program, and a control method.

### 2. Description of Related Art

Techniques capable of evaluating a service provider such that service users can receive services with security are known. For example, Japanese Patent No. 6319506 discloses an evaluation device and an evaluation system that evaluate a driver of a vehicle based on a response of a passenger in the vehicle.

### SUMMARY

There have been demands by service providers for grasping at a store providing certain services what kind of response an occupant of a vehicle shows when the vehicle travels around the store and improving or enhancing an environment around the store. Such improvement or enhancement of the environment contributes to improvement or enhancement of services at the store. There have been demands by service providers for improving or enhancing services to increase their customer attraction.

In view of such circumstances, the present disclosure provides an information processing system, a program, and a control method that can contribute to improvement or enhancement of services at a store.

An information processing system according to an embodiment of the present disclosure is an information processing system including a vehicle and an information processing apparatus that acquires, from the vehicle, information acquired by the vehicle,

wherein the vehicle is configured to:
acquire information on an occupant inside a vehicle cabin of the vehicle, and
acquire position information of the vehicle, and

wherein the information processing apparatus is configured to:
when determining that the vehicle is to pass a pre-registered point based on the position information of the vehicle, associate at least one of information on the occupant acquired at the point and information calculated based on the information on the occupant with position information of the point, and
provide the information associated with the position information of the point to a service provider for a store located at the point.

A program according to an embodiment of the present disclosure is a program that operates in an information processing system including a vehicle and an information processing apparatus that acquires, from the vehicle, information acquired by the vehicle,

the program causing the vehicle to execute the steps of:
acquiring information on an occupant inside a vehicle cabin of the vehicle; and
acquiring position information of the vehicle, and

the program causing the information processing apparatus to execute the steps of:
determining whether the vehicle is to pass a pre-registered point or not based on the position information of the vehicle;
when determining that the vehicle is to pass the pre-registered point, associating at least one of information on the occupant acquired at the point and information calculated based on the information on the occupant with position information of the point; and
providing the information associated with the position information of the point to a service provider for a store located at the point.

A control method according to an embodiment of the present disclosure is a control method in an information processing system including a vehicle and an information processing apparatus that acquires, from the vehicle, information acquired by the vehicle,

the method including the steps of, at the vehicle:
acquiring information on an occupant inside a vehicle cabin of the vehicle; and
acquiring position information of the vehicle, and

the method including the steps of, at the information processing apparatus:
determining whether the vehicle is to pass a pre-registered point or not based on the position information of the vehicle;
when determining that the vehicle is to pass the pre-registered point, associating at least one of information on the occupant acquired at the point and information calculated based on the information on the occupant with position information of the point; and
providing the information associated with the position information of the point to a service provider for a store located at the point.

The information processing system, program, and control method according to an embodiment of the present disclosure can contribute to improvement or enhancement of services at a store.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a schematic configuration of an information processing system according to an embodiment of the present disclosure;

FIG. 2 is a block diagram showing a schematic configuration of a vehicle;

FIG. 3 is a block diagram showing a schematic configuration of an information processing apparatus;

FIG. 4 shows a specific example of information associated with position information of a point by a control unit of the information processing apparatus; and

FIG. 5 is a sequence diagram showing an example of an operation flow of the information processing system.

### DETAILED DESCRIPTION OF EMBODIMENTS

An embodiment of the present disclosure is now described with reference to the accompanying drawings.

Information Processing System

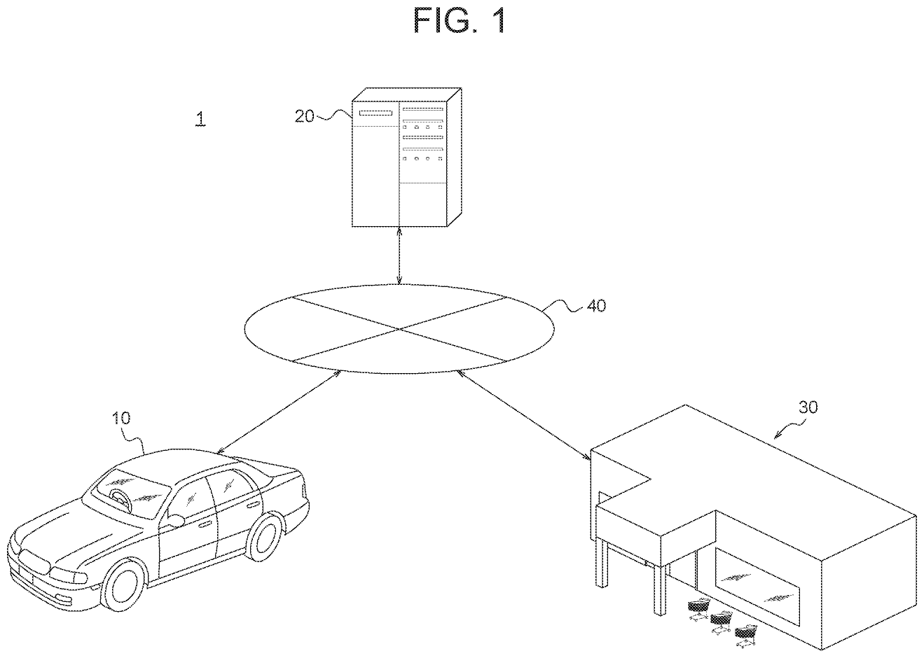

FIG. 1 is a diagram showing a schematic configuration of an information processing system 1 according to an embodiment of the present disclosure. Referring to FIG. 1, mainly the configuration and functionality of the information processing system 1 according to an embodiment of the present disclosure will be described.

The information processing system 1 includes a vehicle 10, an information processing apparatus 20, and an information processing terminal 30 of a store. The vehicle 10, the information processing apparatus 20, and the information processing terminal 30 are each communicatively connected with a network 40, which includes a mobile communication network, Internet, and the like, for example.

The vehicle 10 may be an automobile, for example; however, it is not limited thereto and may be any kind of vehicle on which people can ride. The vehicle 10 is a vehicle operated by a driver; however, it is not limited thereto and may also be a vehicle capable of automated driving, for example. Such automated driving includes Levels 1 through 5 defined by SAE (Society of Automotive Engineers), for example; however, it is not limited thereto and may be defined as desired. Although FIG. 1 shows only one vehicle 10 for the sake of simplicity, the information processing system 1 may include one or more vehicles 10.

The information processing apparatus 20 is a server apparatus, for example; however, it is not limited thereto and may be any kind of general-purpose electronic device, such as a PC (Personal Computer) and a smartphone, or any other electronic device dedicated for the information processing system 1. Although FIG. 1 shows only one information processing apparatus 20 for the sake of simplicity, the information processing system 1 may include one or more information processing apparatuses 20.

The information processing terminal 30 is a PC installed in a store, for example; however, it is not limited thereto and may instead be a smartphone of a service provider in the store or a server apparatus of the service provider installed outside the store.

Generally describing this embodiment, the information processing apparatus 20 acquires from the vehicle 10 over the network 40 information on an occupant of the vehicle 10 and position information of the vehicle 10 which have been acquired by the vehicle 10. The occupants of the vehicle 10 include the driver of the vehicle 10 and passengers. The number of occupants in the vehicle 10 may be either one or multiple. The information processing apparatus 20 determines whether the vehicle 10 is to pass a point pre-registered with the information processing system 1 or not based on the position information of the vehicle 10 and with reference to road map information. The road map information may be either prestored by the information processing apparatus 20 or be acquired from other external information processing device as necessary. When the information processing apparatus 20 determines that the vehicle 10 is to pass the pre-registered points, it associates the information on the occupant acquired at that point with position information of the point. The information processing apparatus 20 provides any kind of information including the information on an occupant associated with the position information of the point to a service provider for a store located at the point.

In this manner, this embodiment allows a service provider for a store registered with the information processing system 1 to directly grasp what kind of response an occupant of the vehicle 10 shows when the vehicle 10 travels around the store. For example, when the response of an occupant of the vehicle 10 is unfavorable in a case where the vehicle 10 passes in front of the store, the service provider can estimate a cause of the unfavorable response of the occupant and improve the environment around the store. Conversely, when the response of an occupant of the vehicle 10 is favorable in a case where the vehicle 10 passes in front of the store, the service provider can estimate the cause of the favorable response of the occupant and enhance the environment around the store.

In this manner, the information processing system 1 feeds back the response of the occupant of the vehicle 10 traveling around the store to a store side, allowing the service provider to be aware of any room for improvement or enhancement of the environment around the store. It is also possible to improve or enhance services at the store through such improvement or enhancement of the environment effected by the service provider. As a result, the service provider can possibly accomplish an improvement in customer attraction to the store.

Next, components of the information processing system 1 are described in greater detail.

Vehicle

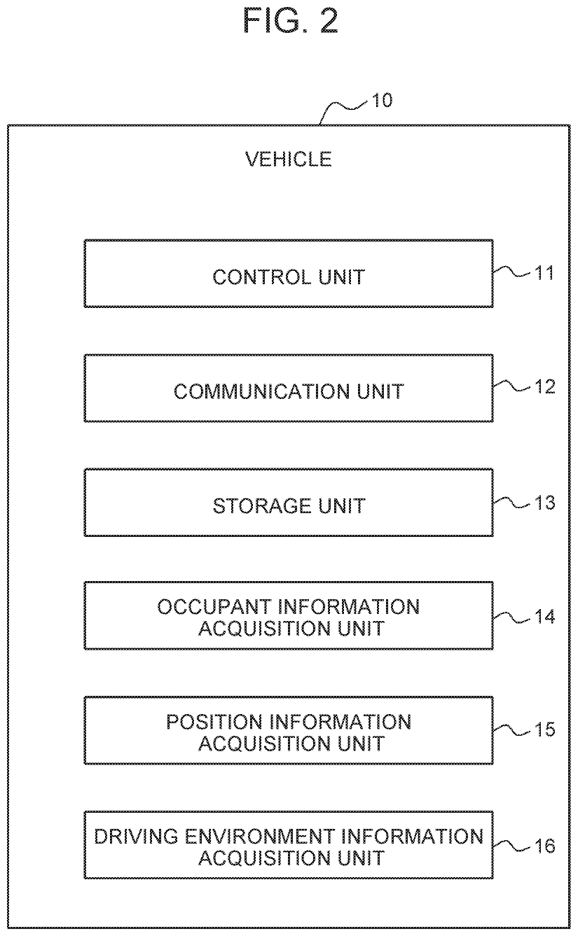

FIG. 2 is a block diagram showing a schematic configuration of the vehicle 10. As shown in FIG. 2, the vehicle 10 has a control unit 11, a communication unit 12, a storage unit 13, an occupant information acquisition unit 14, a position information acquisition unit 15, and a driving environment information acquisition unit 16. These component units constituting the vehicle 10 are communicatively connected with each other via, e.g., an in-vehicle network such as a CAN (Controller Area Network) or a dedicated line.

The control unit 11 has one or more processors. The term “processor” in this embodiment refers to a general-purpose processor or a special-purpose processor specifically designed for a particular kind of processing, although it is not limited thereto.

The control unit 11 is connected, e.g., communicatively, with the component units constituting the vehicle 10, and controls an operation of the vehicle 10 as a whole. In this embodiment, the control unit 11 controls each of the information acquisition units to acquire various kinds of information, for example. For example, the control unit 11 controls the communication unit 12 to transmit various kinds of acquired information to the information processing apparatus 20 over the network 40.

The communication unit 12 includes a communication module that performs communication over the in-vehicle network or the dedicated line. The communication unit 12 includes a communication module of an on-board communication instrument such as a DCM (Data Communication Module), for example. The communication unit 12 includes a communication module that provides connection to the network 40. For example, the communication unit 12 may include a communication module that supports a mobile communication standard, such as 4G (4th Generation) and 5G (5th Generation). In this embodiment, the vehicle 10 is connected with the network 40 via the communication unit 12.

The storage unit 13 includes one or more memories. The term “memory” in this embodiment refers to semiconductor memory, magnetic memory, optical memory or the like, for example, although it is not limited thereto. The memories included in the storage unit 13 may function as main storage, auxiliary storage, or cache memory, for example. The storage unit 13 stores any kind of information for use in the operation of the vehicle 10. For example, the storage unit 13 may store system programs, application programs, road traffic information, road map information, various kinds of information acquired by the individual information acquisition units of the vehicle 10, etc. The information stored in the storage unit 13 may be updatable with information, for example, acquired from the network 40 via the communication unit 12.

The occupant information acquisition unit 14 acquires information on an occupant inside a vehicle cabin of the vehicle 10. In this embodiment, the occupant information acquisition unit 14 includes an in-cabin camera for capturing an inside of the vehicle cabin of the vehicle 10. The occupant information acquisition unit 14 acquires information on an occupant from an image captured by the in-cabin camera, for example. In that case, the information on an occupant includes at least one of facial expression, face orientation, line of sight, eye blink state, motions, words and actions of an occupant or occupants of the vehicle 10, the number of occupants, their belongings, duration of driving (riding), and attributes including age, sex, nationality, race, and the like. The occupant information acquisition unit 14 may either continuously or periodically acquire information on an occupant.

The occupant information acquisition unit 14 may use, for example, face recognition technology to acquire information on an occupant, such as the occupant's facial expression, face orientation, line of sight, and eye blink state, from an image captured by the in-cabin camera. Alternatively, the occupant information acquisition unit 14 may use any kind of image recognition technology to acquire information on an occupant from an image captured by the in-cabin camera.

The configuration of the occupant information acquisition unit 14 is not limited to what is described above. The occupant information acquisition unit 14 may include any kind of biological sensor installed in the vehicle cabin of the vehicle 10 and connected with the CAN. The occupant information acquisition unit 14 may acquire information on an occupant from output information output by the biological sensor, for example. In that case, information on an occupant may include, for example, biological states of the occupant, including his/her brain wave, cerebral blood flow, blood pressure, blood glucose level, blood amino acids, heartbeat, pulse, body temperature, apparent temperature, hunger sensation, fatigue and the like.

The occupant information acquisition unit 14 may include any kind of sound sensor installed in the vehicle cabin of the vehicle 10 and connected with the CAN. The occupant information acquisition unit 14 may acquire information on an occupant from output information output by the sound sensor, for example. In that case, information on an occupant may include, for example, sound information originating from an occupant or occupants, including content of their conversation, speech generated by an action of an occupant expressing other kind of verbal language, and sound generated by an action of an occupant expressing other kind of sound.

The occupant information acquisition unit 14 may use, for example, speech recognition technology and any other recognition technology to acquire information on an occupant from output information output by the sound sensor.

The position information acquisition unit 15 acquires the position information of the vehicle 10. In this embodiment, the position information acquisition unit 15 includes one or more receivers supporting a certain satellite positioning system. For example, the position information acquisition unit 15 includes a GPS (Global Positioning System) receiver. In that case, the position information acquisition unit 15 acquires the position information of the vehicle 10 based on GPS. The position information includes latitude, longitude, altitude, travel lane position and the like, for example. The position information acquisition unit 15 may either continuously or periodically acquire the position information of the vehicle 10.

The configuration of the position information acquisition unit 15 is not limited to what is described above. The position information acquisition unit 15 may include a Wi-Fi (a registered trademark) receiver. In that case, the position information acquisition unit 15 may acquire the position information of the vehicle 10 based on an access point being connected through Wi-Fi communication provided by the communication unit 12 of the vehicle 10. The position information acquisition unit 15 may also include a geomagnetic sensor, an acceleration sensor, and the like. In that case, the position information acquisition unit 15 may acquire a direction in which the vehicle 10 is oriented.

The driving environment information acquisition unit 16 acquires information on a driving environment of the vehicle 10. In this embodiment, the driving environment information acquisition unit 16 includes an external camera for capturing an outside of the vehicle 10. The driving environment information acquisition unit 16 acquires information on the driving environment from an image captured by the external camera, for example. In that case, information on the driving environment includes, for example, road surface condition, road category, road width, the number of lanes, signal status, congestion condition, signboard information, and traffic participant conditions, such as the number of traffic participants, their features, positions, and speed of movement. The driving environment information acquisition unit 16 may either continuously or periodically acquire information on the driving environment.

The driving environment information acquisition unit 16 may use any kind of image recognition technology to acquire information on the driving environment from an image captured by the external camera.

The configuration of the driving environment information acquisition unit 16 is not limited to what is described above. The driving environment information acquisition unit 16 may include a LIDAR (Light Detecting and Ranging), a radar, a sonar, a speed sensor, and a steering angle sensor, and the like. In that case, information on the driving environment may include, for example, vehicle-ahead condition, vehicle-behind condition, neighboring vehicle condition, and crossing vehicle condition, as well as a speed and a steering state of the vehicle 10.

The driving environment information acquisition unit 16 may include any other sensors connected with the CAN. Such sensors may include an odor sensor, a temperature sensor, a humidity sensor, a sound sensor and the like, for example. The driving environment information acquisition unit 16 may acquire information on the driving environment from output information output by such sensors, for example. In that case, information on the driving environment may include information on odor, temperature, humidity, sound and the like around the vehicle 10, for example.

Information Processing Apparatus

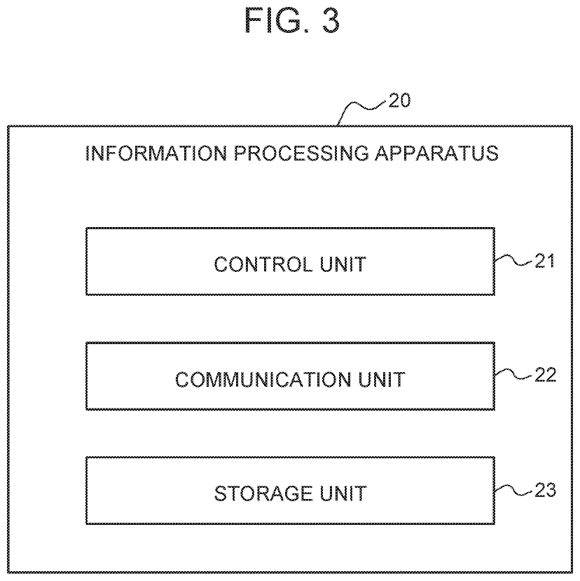

FIG. 3 is a block diagram showing a schematic configuration of the information processing apparatus 20. As shown in FIG. 3, the information processing apparatus 20 has a control unit 21, a communication unit 22, and a storage unit 23.

The control unit 21 has one or more processors. The control unit 21 is connected with the component units constituting the information processing apparatus 20 and controls the operation of the information processing apparatus 20 as a whole. For example, the control unit 21 controls the communication unit 22 to acquire various kinds of information from the vehicle 10 over the network 40.

The communication unit 22 includes a communication module that connects to the network 40. For example, the communication unit 22 may include a communication module that supports a wired LAN (Local Area Network) standard. In this embodiment, the information processing apparatus 20 is connected with the network 40 via the communication unit 22.

The storage unit 23 includes one or more memories. The memories included in the storage unit 23 may function as main storage, auxiliary storage, or cache memory, for example. The storage unit 23 stores any kind of information for use in the operation of the information processing apparatus 20. For example, the storage unit 23 may store system programs, application programs, road traffic information, road map information, and various kinds of information acquired by each of the information acquisition units of the vehicle 10. The information stored in the storage unit 23 may be updatable with information, for example, acquired from the network 40 via the communication unit 22.

The control unit 21 determines whether the vehicle 10 is to pass a pre-registered point P or not based on the position information of the vehicle 10 acquired by the position information acquisition unit 15 of the vehicle 10 with reference to the road map information. The pre-registered point P is a point corresponding to the position information of a store and of its surroundings which is registered beforehand to the information processing system 1 by a service provider that wants to grasp the response of an occupant of the vehicle 10 traveling around the store through feedback from the information processing system 1. There may be one or more points P.

When the control unit 21 determines that the vehicle 10 is to pass the pre-registered point P, it associates various kinds of information acquired by the vehicle 10 at the point P with the position information of the point P. For example, the control unit 21 associates information on an occupant acquired by the occupant information acquisition unit 14 of the vehicle 10 at the point P with the position information of the point P. For example, the control unit 21 associates information on the driving environment acquired by the driving environment information acquisition unit 16 of the vehicle 10 at the point P with the position information of the point P.

The control unit 21 may calculate an occupant's positiveness at the point P based on the information on the occupant acquired by the occupant information acquisition unit 14 of the vehicle 10. The control unit 21 may associate the calculated occupant's positiveness with the position information of the point P.

The occupant's positiveness may be calculated based on a certain metric. For example, the occupant's positiveness may be represented by a numerical value from 0 to 100. A greater value of the occupant's positiveness indicates a more favorable response of the occupant. Conversely, a smaller value of the occupant's positiveness indicates a less favorable response of the occupant. The occupant's positiveness may be calculated per occupant or may be calculated as an average positiveness of the occupants when there are multiple occupants.

The control unit 21 may analyze the cause of the information on the occupant at the point P based on information on the driving environment acquired by the driving environment information acquisition unit 16 of the vehicle 10. The control unit 21 may associate the analyzed cause with the position information of the point P.

The control unit 21 may calculate the occupant's positiveness at the point P by, for example, machine learning, and analyze the cause of the information on the occupant at the point P. The control unit 21 may have any arrangement for learning in order to perform these processes.

The control unit 21 provides such various pieces of information associated with the position information of the point P to the service provider for the store located at the point P. For example, the control unit 21 may use the communication unit 22 to transmit various pieces of information associated with the position information of the point P to the information processing terminal 30 of the store located at the point P. For example, the control unit 21 may store various pieces of information associated with the position information of the point P in the storage unit 23 and make those pieces of information available for viewing by the service provider for the store located at the point P based on an access to the information processing apparatus 20 over the network 40.

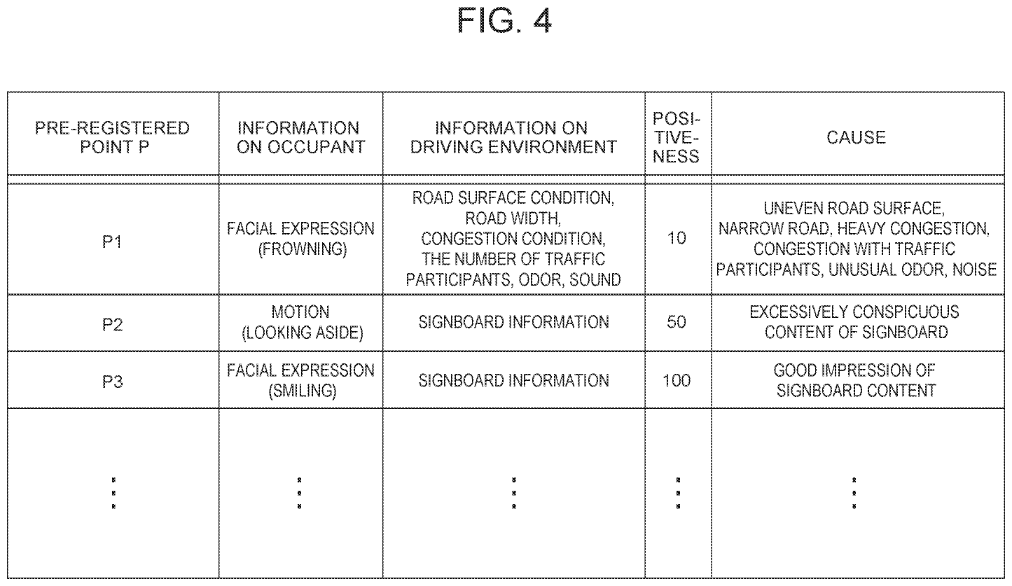

FIG. 4 shows a specific example of the information associated with the position information of the point P by the control unit 21 of the information processing apparatus 20. Referring to FIG. 4, the information associated with the position information of the point P by the control unit 21 is described more specifically.

For example, at a point P1, the occupant information acquisition unit 14 of the vehicle 10 acquires a frowning expression of an occupant from an image captured by the in-cabin camera of the vehicle 10. Here, the driving environment information acquisition unit 16 of the vehicle 10 may acquire at least one of the road surface condition, the road width, the congestion condition, and the number of traffic participants at the point P1 from an image captured by the external camera of the vehicle 10, for example. The driving environment information acquisition unit 16 of the vehicle 10 may acquire information on odor at the point P1 from output information output by the odor sensor of the vehicle 10, for example. The driving environment information acquisition unit 16 of the vehicle 10 may acquire information on sound at the point P1 from output information output by the sound sensor of the vehicle 10, for example.

The control unit 21 of the information processing apparatus 20 acquires these pieces of information from the vehicle 10 over the network 40. The control unit 21 may determine that the occupant's response is unfavorable based on the acquired frowning expression of the occupant and calculate the occupant's positiveness at the point P1 as 10, for example.

The control unit 21 may analyze the cause of the frowning expression of the occupant at the point P1 based on at least one of the road surface condition, the road width, the congestion condition, and the number of traffic participants at the point P1 which have been acquired. By the analysis, the control unit 21 may determine that the cause is a harsh driving condition for the vehicle 10 due to an uneven road surface, for example. By the analysis, the control unit 21 may determine that the cause is a harsh driving condition for the vehicle 10 due to a narrow road, for example. By the analysis, the control unit 21 may determine that the cause is a heavy congestion, for example. By the analysis, the control unit 21 may determine that the cause is difficulty for the vehicle 10 to enter a parking lot of the store due to congestion with traffic participants, for example.

The control unit 21 may analyze the cause of the frowning expression of the occupant at the point P1 based on acquired information on odor at the point P1. By the analysis, the control unit 21 may determine that the cause is an unusual odor wafting around the store, for example.

The control unit 21 may analyze the cause of the frowning expression of the occupant at the point P1 based on the acquired information on sound at the point P1. By the analysis, the control unit 21 may determine that the cause is a big noise around the store, for example.

For example, at a point P2, the occupant information acquisition unit 14 of the vehicle 10 acquires a motion of the driver looking aside during driving from an image captured by the in-cabin camera of the vehicle 10. Here, the driving environment information acquisition unit 16 of the vehicle 10 may acquire signboard information at the point P2 from an image captured by the external camera of the vehicle 10, for example.

The control unit 21 of the information processing apparatus 20 acquires these pieces of information from the vehicle 10 over the network 40. The control unit 21 may determine that the driver's response is normal based on the acquired motion of the driver looking aside during driving and calculate the driver's positiveness at the point P2 as 50, for example.

The control unit 21 may analyze the cause of the motion of the driver looking aside during driving at the point P2 based on the acquired signboard information on a roadside signboard at the point P2. By the analysis, the control unit 21 may determine that the cause is an excessively conspicuous content of the signboard, for example.

For example, at a point P3, the occupant information acquisition unit 14 of the vehicle 10 acquires a smiling expression of an occupant from an image captured by the in-cabin camera of the vehicle 10. Here, the driving environment information acquisition unit 16 of the vehicle 10 may acquire signboard information at the point P3 from an image captured by the external camera of the vehicle 10, for example.

The control unit 21 of the information processing apparatus 20 acquires these pieces of information from the vehicle 10 over the network 40. The control unit 21 may determine that the occupant's response is favorable based on the acquired smiling expression of the occupant and calculate the occupant's positiveness at the point P3 as 100, for example.

The control unit 21 may analyze the cause of the smiling expression of the occupant at the point P3 based on the acquired signboard information on a roadside signboard at the point P3. By the analysis, the control unit 21 may determine that the cause is a good impression made by the content of the signboard, for example.

Operation Flow of Information Processing System

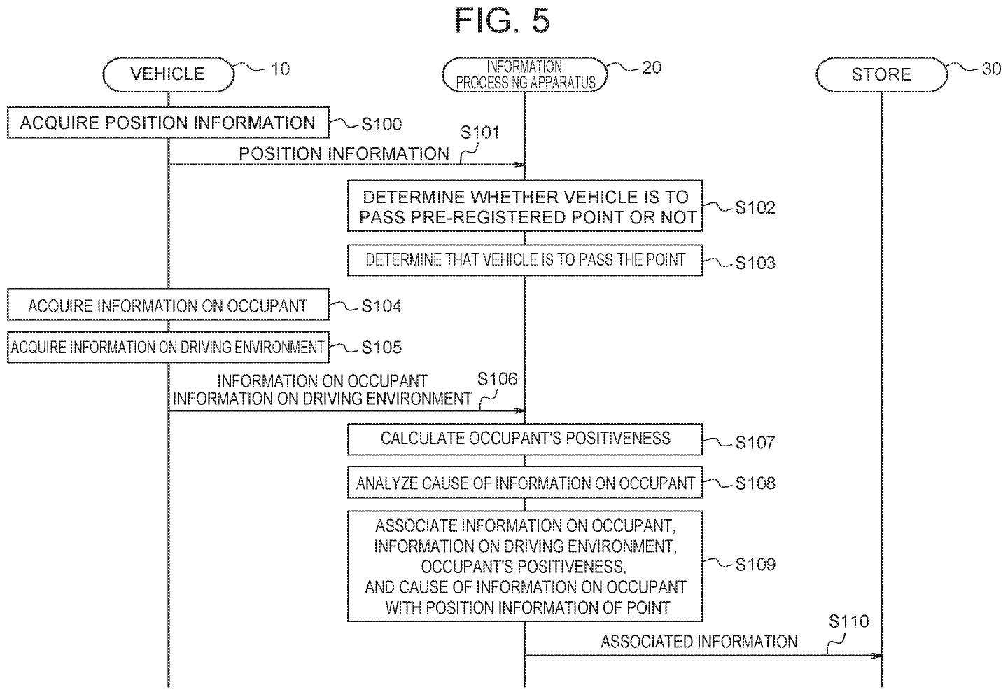

FIG. 5 is a sequence diagram showing an example of an operation flow of the information processing system 1. Referring to FIG. 5, an example of the operation flow of the information processing system 1 is described.

Step S100: the control unit 11 of the vehicle 10 acquires the position information of the vehicle 10 through the position information acquisition unit 15.

Step S101: the control unit 11 of the vehicle 10 transmits the position information of the vehicle 10 acquired at step S100 to the information processing apparatus 20 through the communication unit 12. For example, the control unit 21 of the information processing apparatus 20 continuously acquires the position information of the vehicle 10 from the communication unit 12.

Step S102: the control unit 21 of the information processing apparatus 20 determines whether the vehicle 10 is to pass the pre-registered point P based on the position information of the vehicle 10 acquired from the vehicle 10.

Step S103: the control unit 21 of the information processing apparatus 20 determines that the vehicle 10 is to pass the pre-registered point P based on the position information of the vehicle 10 acquired from the vehicle 10.

Step S104: the control unit 11 of the vehicle 10 acquires information on an occupant inside the vehicle cabin of the vehicle 10 through the occupant information acquisition unit 14.

Step S105: the control unit 11 of the vehicle 10 acquires information on the driving environment of the vehicle 10 through the driving environment information acquisition unit 16.

Step S106: the control unit 11 of the vehicle 10 transmits the information on the occupant acquired at step S104 and the information on the driving environment acquired at step S105 to the information processing apparatus 20 through the communication unit 12.

In FIG. 5, the control unit 21 of the information processing apparatus 20 is described as determining that the vehicle 10 is to pass the pre-registered point P at step S103 and then acquiring information on an occupant and information on the driving environment; however, the operation flow is not limited thereto. The control unit 21 of the information processing apparatus 20 may continuously acquire these pieces of information from the vehicle 10.

Step S107: when the control unit 21 of the information processing apparatus 20 determines that the vehicle 10 is to pass the pre-registered point P at step S103, the control unit 21 calculates the occupant's positiveness at the point P based on the information on an occupant acquired at the point P.

Step S108: the control unit 21 of the information processing apparatus 20 analyzes the cause of the information on the occupant at the point P based on the information on the driving environment acquired at the point P.

Step S109: the control unit 21 of the information processing apparatus 20 associates, with the position information of the point P, the information on the occupant and the information on the driving environment acquired from the vehicle 10 as well as the calculated occupant's positiveness and the analyzed cause of the information on the occupant.

Step S110: the control unit 21 of the information processing apparatus 20 provides the various pieces of information associated with the position information of the point P at step S109 to the service provider for the store located at the point P.

As described above, the information processing system 1 according to this embodiment can contribute to improvement or enhancement of services at a store registered with the information processing system 1. More specifically, with provision of various pieces of information associated with the position information of the point P where the store is located from the information processing system 1 to the service provider for the store, the service provider can directly grasp what kind of response an occupant of the vehicle 10 shows when the vehicle 10 travels around the store. The information processing system 1 feeds back the response of an occupant of the vehicle 10 traveling around the store to the store side, allowing the service provider to be aware of any room for improvement or enhancement of the environment around the store.

With provision of information on the driving environment acquired at the point P from the information processing system 1 to the service provider for the store, the service provider can more accurately estimate the cause of the response of an occupant of the vehicle 10 around the store. The service provider accordingly can make an appropriate improvement or enhancement to the environment around the store. In this manner, the information processing system 1 can contribute to improvement or enhancement of services at the store more effectively.

By the information processing system 1 analyzing the cause of information on an occupant at the point P based on information on the driving environment, the information processing system 1 can provide the service provider with information more beneficial for the service provider. Grasping the cause analyzed by the information processing system 1, the service provider can make a more appropriate improvement or enhancement to the environment around the store. In this manner, the information processing system 1 can contribute to improvement or enhancement of services at the store further effectively.

By the information processing system 1 acquiring information on the driving environment from an image captured by the external camera, the information processing system 1 can acquire information on the driving environment around the store based on visual information. This enables the information processing system 1 to provide the information on the driving environment at the point P to the service provider as visual information. The service provider can visually ascertain the cause of a response of an occupant in the vehicle 10 around the store based on the information on the driving environment acquired from the information processing system 1 as visual information.

By the information processing system 1 acquiring information on the driving environment from an image captured by the external camera, the information processing system 1 can accurately analyze the cause of the information on the occupant at the point P in a case where the cause is based on information on a visual driving environment.

By the information processing system 1 calculating the occupant's positiveness at the point P based on information on an occupant, the information processing system 1 can provide a response of the occupant of the vehicle 10 around the store to the service provider as more objective information. The service provider can grasp the occupant's positiveness calculated by the information processing system 1 as an objective metric. The service provider accordingly can objectively grasp whether a current environment around the store is good or not.

By the information processing system 1 acquiring information on an occupant from an image captured by the in-cabin camera, the information processing system 1 can acquire information on an occupant around the store based on visual information. This enables the information processing system 1 to provide the information on the occupant at the point P to the service provider as visual information. The service provider can visually ascertain the response of the occupant of the vehicle 10 around the store based on the information on the occupant acquired as visual information from the information processing system 1.

By transmission of information associated with the position information of the point P from the information processing system 1 to the information processing terminal 30 of the store located at the point P, convenience of the service provider is enhanced. The service provider can easily get information necessary for improvement or enhancement of services at the store without having to accessing the information processing apparatus 20.

While the present disclosure has been described with reference to the drawings and embodiments, it is to be noted that those skilled in the art could easily make various alternations and modifications based on the present disclosure. Thus, it is to be noted that such alternations and modifications would be encompassed in the scope of the present disclosure. For example, functions or the like included in different means or steps could be rearranged without creating logical inconsistency or multiple means or steps could be combined into one means or step or be subdivided.

For example, in the foregoing embodiment, the component units of the vehicle 10 are described as being mounted on the vehicle 10. However, a configuration is also possible where some or all of processing operations performed by the component units of the vehicle 10 are performed by any electronic device such as a smartphone or a computer.

For example, a configuration is also possible where a general-purpose electronic device such as a smartphone or a computer is made to function as the component units of the vehicle 10 or as the information processing apparatus 20 according to the above-described embodiment. For example, a program describing processing actions for implementing the functions of the communication unit 12 and the like according to the embodiment is stored in the memory of the electronic device and the program is read and executed by the processor of the electronic device. Thus, the disclosure according to this embodiment can be also implemented as a processor-executable program.

In the foregoing embodiment, the vehicle 10 and the information processing apparatus 20 are described as being communicatively connected with each other over the network 40. However, a configuration is also possible where the information processing apparatus 20 is mounted on the vehicle 10 itself such that information acquired by the vehicle 10 is directly acquired from the vehicle 10 without through the network 40. In that case, the control unit 11 and the control unit 21 may be composed of different processors and separately included in the vehicle 10 and the information processing apparatus 20, respectively, as with the foregoing embodiment. Or as opposed to the foregoing embodiment, the control unit 11 and the control unit 21 may be composed of one and the same processor such that they are arranged as a single control unit included in both the vehicle 10 and the information processing apparatus 20. That is, the processing operations of the vehicle 10 and the information processing apparatus 20 described above may be implemented by a single control unit.

In the foregoing embodiment, the information processing system 1 is described as providing both information on an occupant acquired at the point P and the occupant's positiveness calculated based on the information on the occupant to the service provider in association with the position information of the point P. However, a configuration is also possible where the information processing system 1 provides either one of the information on the occupant acquired at the point P and the occupant's positiveness calculated based on the information on the occupant to the service provider in association with the position information of the point P.

In the foregoing embodiment, the information processing system 1 is described as providing information on the driving environment at the point P acquired by the driving environment information acquisition unit 16 of the vehicle 10 to the service provider in association with the position information of the point P. However, a configuration is also possible where the information processing system 1 does not associated information on the driving environment with the position information of the point P or provide it to the service provider.

In the foregoing embodiment, the information processing system 1 is described as analyzing the cause of the information on an occupant at the point P and providing the analyzed cause to the service provider in association with the position information of the point P. However, a configuration is also possible where the information processing system 1 does not associate the analyzed cause with the position information of the point P or provide it to the service provider.

In the foregoing embodiment, the information processing system 1 is described as calculating the occupant's positiveness at the point P based on information on an occupant. However, information calculated based on information on an occupant is not limited to the occupant's positiveness at the point P. Information calculated based on information on an occupant may also be any metric associated with an occupant's response, including the occupant's comfort level, surprise level, boredom level, frustration level, relaxation level or the like at the point P.

What is claimed is:

1. An information processing system comprising a vehicle and an information processing apparatus that acquires, from the vehicle, information acquired by the vehicle,
wherein the vehicle is configured to:
acquire information on an occupant inside a vehicle cabin of the vehicle, and
acquire position information of the vehicle, and
wherein the information processing apparatus is configured to:
when determining that the vehicle is to pass a pre-registered point based on the position information of the vehicle, associate at least one of information on the occupant acquired at the point and information calculated based on the information on the occupant with position information of the point, and
provide the information associated with the position information of the point to a service provider for a store located at the point.

2. The information processing system according to claim 1, wherein:
the vehicle acquires information on a driving environment of the vehicle; and
when the information processing apparatus determines that the vehicle is to pass the pre-registered point, the information processing apparatus associates information on the driving environment acquired at the point with the position information of the point.

3. The information processing system according to claim 2, wherein the information processing apparatus analyzes a cause of information on the occupant at the point based on the information on the driving environment and associates the analyzed cause with the position information of the point.

4. The information processing system according to claim 2, wherein the vehicle comprises an external camera for capturing an outside of the vehicle, and acquires information on the driving environment from an image captured by the external camera.

5. The information processing system according to claim 1, wherein the information calculated based on information on the occupant comprises a positiveness of the occupant regarding the point.

6. The information processing system according to claim 1, wherein:
the vehicle comprises an in-cabin camera for capturing an inside of a vehicle cabin of the vehicle, and acquires information on the occupant from an image captured by the in-cabin camera; and
the information on the occupant comprises at least one of a facial expression and a motion of the occupant.

7. The information processing system according to claim 1, wherein the information processing apparatus transmits information associated with position information of the point to an information processing terminal of the store located at the point.

8. A program that operates in an information processing system comprising a vehicle and an information processing apparatus that acquires, from the vehicle, information acquired by the vehicle,
the program causing the vehicle to execute the steps of:
acquiring information on an occupant inside a vehicle cabin of the vehicle; and
acquiring position information of the vehicle, and
the program causing the information processing apparatus to execute the steps of:
determining whether the vehicle is to pass a pre-registered point or not based on the position information of the vehicle;
when determining that the vehicle is to pass the pre-registered point, associating at least one of information on the occupant acquired at the point and information calculated based on the information on the occupant with position information of the point; and
providing the information associated with the position information of the point to a service provider for a store located at the point.

9. A control method in an information processing system comprising a vehicle and an information processing apparatus that acquires, from the vehicle, information acquired by the vehicle,
the method comprising the steps of, at the vehicle:
acquiring information on an occupant inside a vehicle cabin of the vehicle; and
acquiring position information of the vehicle, and
the method comprising the steps of, at the information processing apparatus:
determining whether the vehicle is to pass a pre-registered point or not based on the position information of the vehicle;
when determining that the vehicle is to pass the pre-registered point, associating at least one of information on the occupant acquired at the point and information calculated based on the information on the occupant with position information of the point; and
providing the information associated with the position information of the point to a service provider for a store located at the point.
